(19) United States
(12) Patent Application Publication
(10) Pub. No.: US 2025/0286117 A1
(43) Pub. Date: Sep. 11, 2025

(54) Sodium-ion Secondary Battery

(71) Applicant: SHENZHEN CAPCHEM TECHNOLOGY CO., LTD., Shenzhen (CN)

(72) Inventors: Zhongbo Liu, Shenzhen (CN); Yang Liu, Shenzhen (CN); Xiaohu Ao, Shenzhen (CN); Qiangqiang Zhang, Shenzhen (CN); Zhongtian Zheng, Shenzhen (CN)

(21) Appl. No.: 19/219,997

(22) Filed: May 27, 2025

Related U.S. Application Data
(63) Continuation of application No. PCT/CN2023/124722, filed on Oct. 16, 2023.

(30) Foreign Application Priority Data
Nov. 29, 2022 (CN) 202211509242.4

(51) Int. Cl. H01M 10/054; H01M 4/02; H01M 4/505; H01M 4/525; H01M 4/583; H01M 10/0567; H01M 10/0568; H01M 10/0569

(52) U.S. Cl. CPC H01M 10/054; H01M 4/505; H01M 4/525; H01M 4/583; H01M 10/0567; H01M 10/0568; H01M 10/0569; H01M 2004/021; H01M 2004/027; H01M 2004/028; H01M 2300/0034; H01M 2300/0037

(57) ABSTRACT

Provided is a sodium-ion secondary battery, comprising a positive electrode, a negative electrode, and an electrolyte, wherein the negative electrode comprises a negative electrode active material, the electrolyte comprises a sodium salt, an additive, and a non-aqueous organic solvent, the additive comprises a cyclic sulfate ester, and the non-aqueous organic solvent comprises a fluoroether solvent represented by Structural Formula 1:

FₓCₙH₂ₙ₊₁₋ₓOCₘH₂ₘ₊₁ Structural Formula 1
wherein x/(2n+1)<0.8, n/m>1.5; 4≤n≤10, 1≤m≤5;
the sodium-ion secondary battery satisfies the following relational expression:

$$0.9 \leq ( a \cdot d ) / ( b \cdot c ) \leq 20 ;$$

wherein, 8%≤a≤25%, 0.5%≤b≤3%, 4 m²/g≤c≤7 m²/g.
   The sodium-ion secondary battery provided by the present application can improve the cycle performance and first-cycle efficiency of the sodium-ion secondary battery.

### CROSS-REFERENCE TO RELATED APPLICATIONS

The present application is a continuation application of PCT application No. PCT/CN2023/124722 filed on Oct. 16, 2023, which claims the benefit of Chinese Patent Application No. 202211509242.4 filed on Nov. 29, 2022. The contents of all of the aforementioned applications are incorporated by reference herein in their entirety.

### TECHNICAL FIELD

The present application belongs to the technical field of sodium-ion secondary batteries, specifically involving a sodium-ion secondary battery.

### BACKGROUND

Sodium-ion batteries started almost simultaneously with lithium-ion batteries. Compared to lithium, sodium accounts for approximately 2.64% of the Earth's elemental reserves, and the methods for obtaining it are much simpler. Compared to lithium-ion batteries, sodium-ion batteries have a cost advantage. The working principle of sodium-ion batteries is similar to that of lithium-ion batteries, utilizing the intercalation and de-intercalation processes of sodium ions between the positive and negative electrodes for charging and discharging. In comparison with lithium batteries, sodium-ion batteries have abundant resources, low cost, and less price fluctuation. They also feature a wide temperature range and high safety, offering substantial potential as an alternative. Therefore, developing high-performance, low-cost sodium-ion batteries is a critical factor in determining their industrialization potential.

Currently, the negative electrode materials for sodium-ion batteries mainly consist of biomass hard carbon. However, hard carbon prepared by low-temperature carbonization, while having high ionic conductivity, suffers from low first-cycle efficiency and unstable cycle performance. Sodium-ion batteries utilize the intercalation and de-intercalation of sodium ions between the positive and negative electrodes for charging and discharging. However, sodium ions have a larger radius than lithium ions, which results in poor migration and diffusion properties of sodium ions in the electrolyte during the charging and discharging processes. This leads to high insertion barriers, ultimately causing poor cycle performance in sodium-ion batteries.

### SUMMARY OF THE INVENTION

In response to the issues of low cycle performance and low first-cycle efficiency in existing sodium-ion batteries, the present application provides a sodium-ion secondary battery.

In one aspect, the present application provides a sodium-ion secondary battery, comprising a positive electrode, a negative electrode, and an electrolyte, wherein the negative electrode comprises a negative electrode active material, the electrolyte comprises a sodium salt, an additive, and a non-aqueous organic solvent, the additive comprises a cyclic sulfate ester, and the non-aqueous organic solvent comprises a fluoroether solvent represented by Structural Formula 1:

FₓCₙH₂ₙ₊₁₋ₓOCₘH₂ₘ₊₁ Structural Formula 1
wherein x/(2n+1)<0.8, n/m>1.5; 4≤n≤10, 1≤m≤5;
the sodium-ion secondary battery satisfies the following relational expression:

$$0.9 \leq ( a \cdot d ) / ( b \cdot c ) \leq 20 ;$$

wherein, 8%≤a≤25%, 0.5%≤b≤3%, 4 m²/g≤c≤7 m²/g;
a represents a mass percentage content of the fluoroether solvent represented by Structural Formula 1 in the electrolyte, in %;
b represents a mass percentage content of the cyclic sulfate ester in the electrolyte, in %;
c represents a specific surface area of the negative electrode active material, in m²/g; and
d represents a viscosity of the electrolyte at 25° C., in mPa·s.

Preferably, the sodium-ion secondary battery satisfies the following relational expression:

2≤(a·d)/(b·c)≤16.

Preferably, the fluoroether solvent represented by Structural Formula 1 comprises one or more of the following:
2,2,3,3,4,4,5,5-octafluoropentyl methyl ether, 2,2,3,3,4,4,5,5-octafluoropentyl ethyl ether, 2,3,3,4,4,5,5-heptafluoropentyl methyl ether, 2,3,3,4,4,5,5-heptafluoropentyl ethyl ether, 2,2,3,3,4,4,5-heptafluoropentyl methyl ether, 2,2,3,3,4,4,5-heptafluoropentyl ethyl ether, 3,3,4,4,5,5-hexafluoropentyl methyl ether, 3,3,4,4,5,5-hexafluoropentyl ethyl ether, 2,2,3,3,4,4-hexafluorobutyl methyl ether, 2,2,3,3,4,4-hexafluoropentyl methyl ether and 2,2,3,3,4,4-hexafluorobutyl ethyl ether.

Preferably, the fluoroether solvent represented by Structural Formula 1 comprises one or more of the following:
2,2,3,3,4,4,5,5-octafluoropentyl ethyl ether, 2,2,3,3,4,4,5,5-octafluoropentyl methyl ether and 2,3,3,4,4,5,5-heptafluoropentyl methyl ether.

Preferably, the mass percentage content (a) of the fluoroether solvent represented by Structural Formula 1 is 10%-22%, based on 100% by mass of the electrolyte.

Preferably, the cyclic sulfate ester comprises one or more of the following:
1,3-propane sultone, 1,3-propene sultone, ethylene sulfate, 4-methyl ethyl sulfate, 4-propyl ethyl sulfate, propylene sulfate, 4-methyl propyl sulfate and 4-propyl propylene sulfate.

Preferably, the mass percentage content (b) of the cyclic sulfate ester is 1%-3%, based on 100% by mass of the electrolyte.

Preferably, the cyclic sulfate ester is ethylene sulfate.

Preferably, the cyclic sulfate ester is 1,3-propene sultone.

Preferably, the cyclic sulfate ester consists of one or both of 1,3-propene sultone and ethylene sulfate. The negative electrode active material comprises one or more of soft carbon, hard carbon, carbon nanotubes, expanded graphite, and graphene.

Preferably, the specific surface area (c) of the negative electrode active material is 4 m²/g to 6 m²/g.

Preferably, the sodium salt includes one or more of sodium perchlorate (NaClO₄), sodium tetrafluoroborate (NaBF₄), sodium hexafluorophosphate (NaPF₆), sodium trifluoroacetate (CF₃COONa), sodium tetraphenylborate (NaB(C₆H₅)₄), sodium trifluoromethanesulfonate (NaSO₃CF₃), sodium bis(fluorosulfonyl)imide (Na[(FSO₂)₂N]), and sodium bis(trifluoromethylsulfonyl)imide (Na[(CF₃SO₂)₂N]).

Preferably, the mass percentage content of sodium salt in the electrolyte is 8%-15%, based on 100% by mass of the electrolyte.

Preferably, the non-aqueous organic solvent further comprises an auxiliary solvent, and the auxiliary solvent comprises one or more of carbonates, carboxylates, and ethers.

Preferably, the carbonate comprises a cyclic carbonate or linear carbonate with 3 to 5 carbon atoms, the cyclic carbonate comprises one or more of ethylene carbonate, vinylene carbonate, vinyl ethylene carbonate, propylene carbonate, γ-butyrolactone, and butylene carbonate; the linear carbonate comprises one or more of dimethyl carbonate, ethyl methyl carbonate, diethyl carbonate and dipropyl carbonate;
the carboxylate comprises a carboxylate with 2 to 6 carbon atoms, the carboxylate comprises one or more of methyl acetate, ethyl acetate, propyl acetate, butyl acetate, and propyl propionate with 2 to 6 carbon atoms;
the ether comprises a cyclic ether or linear ether with 4 to 10 carbon atoms, the cyclic ether comprises one or more of 1,3-dioxolane, 1,4-dioxooxane (DX), tetrahydrofuran, 2-methyltetrahydrofuran and 2-trifluoromethyltetrahydrofuran; the linear ether comprises one or more of dimethoxymethane, 1,2-dimethoxyethane (DME), and diglyme; and
the mass percentage content of the auxiliary solvent is 60%-85%, based on 100% by mass of the electrolyte, and the preferable range is 65%-80%.

Preferably, the additive further includes a fluorinated carbonate ester.

Preferably, fluorinated carbonate ester comprises one or both of fluoroethylene carbonate and difluoroethylene carbonate;
the mass percentage content of the fluorinated carbonate ester is 1%-5%, based on 100% by mass of the electrolyte.
the positive electrode comprises a positive electrode active material, the positive electrode active material comprises one or more of sodium-containing layered oxides, sodium-containing polyanion compounds, and sodium-containing Prussian blue compounds; and
the sodium-containing layered oxide comprises one or more compounds represented by Formula (1):

NaᵢMO₂ (Formula 1)
wherein 0<i≤1, and M is selected from one or more of V, Cr, Mn, Fe, Co, Ni and Cu.

Preferably, the sodium-containing layered oxide comprises one or more of Na[Cu_{1/9}Ni_{2/9}Fe_{1/3}Mn_{1/3}]O₂, Na_{0.44}MnO₂, Na_{2/3}[Fe_{1/2}Mn_{1/2}]O₂, Na[Ni_{1/3}Fe_{1/3}Mn_{1/3}]O₂,
Na_{7/9}[Cu_{2/9}Fe_{1/9}Mn_{2/3}]O₂ and NaNi_{0.7}Co_{0.15}Mn_{0.15}O₂;
the sodium-containing polyanion compound comprises Na₃V₂(PO₄)₂F₃; and
the sodium-containing Prussian blue compound comprises one or more compounds represented by Formula (2):
AₓM″[M′(CN)₆]_{1-y}·□_{y}·zH₂O (Formula 2), wherein 0≤x≤2, 0≤y<1, 0<z≤20; A is an alkali metal ion, M″ is a transition metal coordinated with N, M′ is a transition metal coordinated with C, and □ represents a vacancy in [M′(CN)₆].

Preferably, A is selected from one or more of K⁺ and Na⁺; M″ is selected from one or more of Ti, V, Cr, Mn, Fe, Co, Ni, Cu and Zn; M′ is selected from one or more of Ti, V, Cr, Mn, Fe, Co, Ni, Cu and Zn.

In another aspect, the present application provides a method for preparing a sodium-ion secondary battery, comprising the following steps:
Preparation of the positive electrode: uniformly mixing a positive electrode active material, a binder, a conductive agent, and a solvent, coating the mixture onto a substrate, and removing the solvent to obtain a positive electrode;
Preparation of the negative electrode: uniformly mixing a negative electrode active material, a binder, a conductive agent, and a solvent, coating the mixture onto a substrate, and removing the solvent to obtain a negative electrode;
Preparation of the electrolyte: uniformly mixing a sodium salt, an additive, and a non-aqueous organic solvent to obtain an electrolyte, wherein the additive comprises a cyclic sulfate ester, and the non-aqueous organic solvent comprises a fluoroether solvent represented by Structural Formula 1; and
Assembly of the sodium-ion secondary battery: assembling the positive electrode, the negative electrode, and the electrolyte to obtain a sodium-ion secondary battery.

### Technical Benefits

This application provides a sodium-ion secondary battery in which the fluoroether solvent of structural formula 1 can participate in the ion solvation structure, forming a structurally stable SEI and CEI film on the surface of the electrode material. This enhances the interfacial stability between the electrode material and electrolyte, thereby improving the cycle performance of the sodium-ion secondary battery. The cyclic sulfate ester compound can suppress side reactions during the formation stage of the battery, reducing irreversible capacity loss and thereby improving the first-cycle efficiency of the sodium-ion secondary battery. By limiting the specific surface area “c” of the negative electrode active material within the range of 4 m²/g≤c≤7 m²/g, electrolyte consumption is reduced, ensuring full capacity utilization of the battery, thereby further enhancing first-cycle efficiency.

By incorporating the fluoroether solvent represented by Structural Formula 1 at a mass percentage content “a” of 8%-25% and the cyclic sulfate ester compound at a mass percentage content “b” of 0.5%-3% in the electrolyte, while maintaining the specific surface area “c” of the negative electrode active material within the range of 4 m²/g≤c≤7 m²/g, and ensuring that the sodium-ion secondary battery satisfies the relationship 0.9≤(a·d)/(b·c)≤20, the cycle performance and first-cycle efficiency of the battery can be improved.

### DETAILED DESCRIPTION OF DISCLOSED EMBODIMENTS

To make the technical problems, technical solutions and beneficial effects of the present application more clear, the application will be further explained in detail below with reference to the drawings and embodiments. It should be understood that the specific embodiments described here are only used to illustrate the application, rather than to limit the application.

An embodiment of the present application provides a sodium-ion secondary battery, comprising a positive electrode, a negative electrode, and an electrolyte, wherein the negative electrode comprises a negative electrode active material, the electrolyte comprises a sodium salt, an additive, and a non-aqueous organic solvent, the additive comprises a cyclic sulfate ester, and the non-aqueous organic solvent comprises a fluoroether solvent represented by Structural Formula 1:

FₓCₙH₂ₙ₊₁₋ₓOCₘH₂ₘ₊₁ Structural Formula 1
wherein x/(2n+1)<0.8, n/m>1.5; 4≤n≤10, 1≤m≤5;
the sodium-ion secondary battery satisfies the following relational expression:

$$0.9 \leq ( a \cdot d ) / ( b \cdot c ) \leq 20 ;$$

wherein, 8%≤a≤25%, 0.5%≤b≤3%, 4 m²/g≤c≤7 m²/g;
a represents a mass percentage content of the fluoroether solvent represented by Structural Formula 1 in the electrolyte, in %;
b represents a mass percentage content of the cyclic sulfate ester in the electrolyte, in %;
c represents a specific surface area of the negative electrode active material, in m²/g; and
d represents a viscosity of the electrolyte at 25° C., in mPa·s.

In the electrolyte of the sodium-ion secondary battery, a fluoroether solvent represented by Structural Formula 1 is added at a mass content of 8%-25%, with the constraints x/(2n+1)<0.8, n/m>1.5, 4≤n≤10, and 1≤m≤5. The fluoroether solvent represented by Structural Formula 1 can partially replace organic solvents such as ethyl methyl carbonate and form a co-solvent with the auxiliary solvent, participating in the solvation structure of ions. This influences the composition of the solid electrolyte interphase (SEI) and cathode electrolyte interphase (CEI) films on the electrode material surface, enabling the formation of structurally stable SEI and CEI films, thereby enhancing the interfacial stability between the electrode material and the electrolyte, which improves the cycle performance of the sodium-ion secondary battery. Additionally, the addition of a cyclic sulfate ester compound at a mass content of 0.5 wt %-3 wt % can suppress side reactions during the formation stage of the battery, reducing irreversible capacity loss and ultimately improving the first-cycle efficiency of the sodium-ion secondary battery. In this application, the specific surface area (c) of the negative electrode active material is limited to the range of 4 m²/g≤c≤7 m²/g, which helps reduce electrolyte consumption, ensures that the hard carbon negative electrode maintains sufficient plateau capacity, and guarantees effective capacity utilization, thereby enhancing the first-cycle efficiency.

The fluoroether solvent represented by Structural Formula 1, provided in this application, can partially replace organic solvents such as ethyl methyl carbonate. By adjusting its combination ratio with cyclic sulfate ester and defining the specific surface area range of the hard carbon negative electrode, this application effectively addresses the issue of low cycle performance in existing sodium-ion batteries. Moreover, it overcomes the drawback of excessively high or low specific surface area of the negative electrode active material, which can lead to poor first-cycle efficiency. As a result, it achieves the dual objectives of improving both the first-cycle efficiency and cycle performance of sodium-ion batteries.

Through extensive research, the inventors have discovered that when the fluoroether solvent represented by Structural Formula 1 is added to the electrolyte: if n/m≤1.5, the dipole moment of the fluoroether solvent decreases, leading to reduced solubility of sodium salt and a significant decline in the rate performance of the battery; if x/(2n+1)≥0.8, the fluoroether solvent's ability to dissolve the salt decreases, resulting in lower electrolyte conductivity and severely compromised low-temperature discharge performance. The fluoroether solvent represented by Structural Formula 1 in this application meets the conditions x/(2n+1)<0.8 and n/m>1.5, thereby enhancing the solubility of sodium salt in the electrolyte. This ensures a sufficient concentration of sodium salt in the electrolyte, maintains electrolyte conductivity, and improves the cycle performance, rate performance, and low-temperature discharge performance of sodium-ion secondary batteries.

In the electrolyte, the fluoroether solvent represented by Structural Formula 1 is added with a mass percentage content (a) ranging from 8% to 25%. This ensures the viscosity of the electrolyte, improves the solubility of sodium salt, and increases the electrolyte conductivity. The mass percentage content (a) of the fluoroether solvent can be selected from values such as 8%, 10%, 15%, 18%, 20%, 23%, or 25%, depending on the actual needs, as long as the content is within the 8%-25% range. If the fluoroether solvent's mass percentage content exceeds 25%, the viscosity of the electrolyte increases, making it difficult to dissolve the sodium salt, thereby reducing the sodium salt content. Conversely, if the mass percentage content is below 8%, the electrolyte's conductivity becomes too low.

The mass percentage content (b) of cyclic sulfate ester in the electrolyte is between 0.5% and 3%, which helps the formation of the CEI and SEI films at the electrode material interface, improving the first-cycle efficiency and cycle performance of the sodium-ion secondary battery. The mass percentage content (b) of cyclic sulfate ester can be selected from values such as 0.5%, 0.8%, 1.0%, 1.2%, 1.6%, 2.0%, 2.3%, 2.5%, 2.9%, or 3.0%, depending on the actual needs, as long as the content is within the 0.5%-3% range. If the content of cyclic sulfate ester exceeds 3%, the increased amount of additives in the electrolyte causes the cyclic carbonate additives to excessively participate in the formation of the CEI and SEI films at the electrode material interface, resulting in thicker films, which in turn increases battery impedance. If the content of cyclic sulfate ester is lower than 0.5%, the formation of the film on the electrode material surface will be insufficient, leading to degraded first-cycle efficiency and reduced cycle performance of the sodium-ion secondary battery.

In sodium-ion secondary batteries, the specific surface area refers to the total surface area per unit mass of material, measured in m²/g. The specific surface area of the negative electrode active material affects the formation of the SEI film on the surface of the negative electrode, which influences the performance of the sodium-ion battery. The sodium-ion secondary battery provided in this application has a negative electrode active material with a specific surface area (c) ranging from 4 m²/g to 7 m²/g. This range helps to reduce electrolyte consumption, facilitates the infiltration of the electrolyte into the negative electrode, improves electrolyte wettability, ensures the proper performance of the battery capacity, and does not interfere with the formation of the SEI film on the surface of the negative electrode. It also contributes to improving the battery's first-cycle efficiency, cycle performance, and rate capability. The specific surface area (c) of the negative electrode active material can be chosen from values such as 4 m²/g, 4.5 m²/g, 5 m²/g, 5.5 m²/g, 6 m²/g, or 6.5 m²/g, depending on the actual needs. As long as the specific surface area of the negative electrode material falls within the 4 m²/g to 7 m²/g range, it is suitable. If the specific surface area of the negative electrode active material exceeds 7 m²/g, the electrolyte will be excessively consumed, causing a significant decrease in first-cycle efficiency. If the specific surface area is lower than 4 m²/g, the electrode's wettability will deteriorate, making it difficult for the electrolyte to infiltrate the negative electrode. This will also affect the formation of the SEI film on the surface of the negative electrode, degrading the battery's cycle performance and rate capability.

Through extensive experiments, the inventors found that when the sodium-ion secondary battery satisfies the relationship of (a·d)/(b·c)<0.9, the electrolyte excessively participates in the film formation process, resulting in a thick and uneven film. This causes a significant increase in battery impedance, thereby degrading the battery's cycle performance. On the other hand, when the relationship (a·d)/(b·c)>20, the electrolyte exhibits excessively high viscosity at room temperature, leading to poor film formation, exacerbating side reactions, increasing irreversible capacity, and degrading both the first-cycle efficiency and cycle performance.

According to the sodium-ion secondary battery provided in this application, by incorporating the fluoroether solvent represented by Structural Formula 1 at a mass percentage content “a” of 8%-25% and the cyclic sulfate ester compound at a mass percentage content “b” of 0.5%-3% in the electrolyte, while maintaining the specific surface area “c” of the negative electrode active material within the range of 4 m²/g≤c≤7 m²/g, and ensuring that the sodium-ion secondary battery satisfies the relationship 0.9≤(a·d)/(b·c)≤20, the cycle performance and first-cycle efficiency of the battery can be improved.

In some embodiments, the sodium-ion secondary battery satisfies the relationship 2≤(a·d)/(b·c)≤16. When the sodium-ion secondary battery satisfies the relationship of 2≤(a·d)/(b·c)≤16, the electrolyte has a higher conductivity, lower consumption, and better wettability. As a result, the sodium-ion secondary battery exhibits improved cycle performance and first-cycle efficiency.

In some embodiments, the fluoroether solvent represented by Structural Formula 1 includes one or more of the following: 2,2,3,3,4,4,5,5-octafluoropentyl methyl ether, 2,2,3,3,4,4,5,5-octafluoropentyl ethyl ether, 2,3,3,4,4,5,5-heptafluoropentyl methyl ether, 2,3,3,4,4,5,5-heptafluoropentyl ethyl ether, 2,2,3,3,4,4,5-heptafluoropentyl methyl ether, 2,2,3,3,4,4,5-heptafluoropentyl ethyl ether, 3,3,4,4,5,5-hexafluoropentyl methyl ether, 3,3,4,4,5,5-hexafluoropentyl ethyl ether, 2,2,3,3,4,4-hexafluorobutyl methyl ether, 2,2,3,3,4,4-hexafluoropentyl methyl ether and 2,2,3,3,4,4-hexafluorobutyl ethyl ether.

Preferably, the fluoroether solvent represented by Structural Formula 1 comprises 2,2,3,3,4,4,5,5-octafluoropentyl ethyl ether, 2,2,3,3,4,4,5,5-octafluoropentyl methyl ether and 2,3,3,4,4,5,5-heptafluoropentyl methyl ether.

Furthermore, the specific structures of the aforementioned fluoroether compounds may be those shown in the following table:

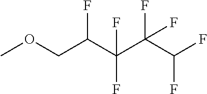

2,3,3,4,4,5,5-heptafluoropentyl methyl ether

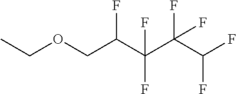

2,3,3,4,4,5,5-heptafluoropentyl ethyl ether

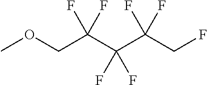

2,2,3,3,4,4,5-heptafluoropentyl methyl ether

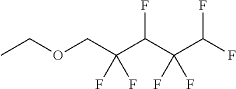

2,2,3,3,4,4,5-heptafluoropentyl ethyl ether

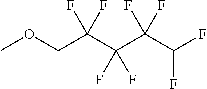

2,2,3,3,4,4,5,5-octafluoropentyl methyl ether

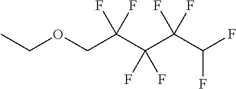 [SMILES: CCOCC(F)(F)C(F)(F)C(F)(F)C(F)F]

2,2,3,3,4,4,5,5-octafluoropentyl ethyl ether

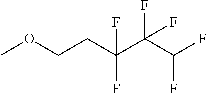

3,3,4,4,5,5-hexafluoropentyl methyl ether

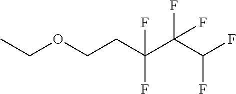

3,3,4,4,5,5-hexafluoropentyl ethyl ether

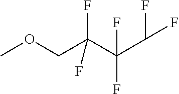

2,2,3,3,4,4-hexafluorobutyl methyl ether

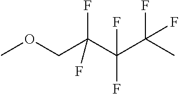

2,2,3,3,4,4-hexafluoropentyl methyl ether

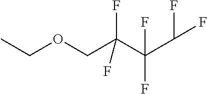

2,2,3,3,4,4-hexafluorobutyl ethyl ether

Based on 100% by mass of the electrolyte, the mass percentage content ‘a’ of the fluoroether solvent represented by Structural Formula 1 is 10%-22%. Specifically, the mass percentage content ‘a’ of the fluoroether solvent represented by Structural Formula 1 in the electrolyte may be 10%, 12%, 14%, 15%, 16%, 17%, 18%, 19%, 20%, 21%, or 22%, as long as the mass percentage content of the fluoroether solvent represented by Structural Formula 1 falls within the range of 10%-22%.

In some embodiments, the cyclic sulfate ester includes one or more of 1,3-propane sultone, 1,3-propene sultone, ethylene sulfate, 4-methyl ethyl sulfate, 4-propyl ethyl sulfate, propylene sulfate, 4-methyl propyl sulfate, and 4-propyl propylene sulfate. Based on 100% by mass of the electrolyte, the mass percentage content ‘b’ of the cyclic sulfate ester is 1%-3%. Specifically, the mass percentage content ‘b’ of the cyclic sulfate ester in the electrolyte may be 1%, 1.2%, 1.5%, 1.7%, 1.9%, 2.0%, 2.2%, 2.5%, 2.8%, 2.9%, or 3.0%, as long as the mass percentage content of the cyclic sulfate ester falls within the range of 1%-3%.

In some preferred embodiments, the cyclic sulfate ester is ethylene sulfate.

In some preferred embodiments, the cyclic sulfate ester is 1,3-propene sultone.

In some preferred embodiments, the cyclic sulfate ester consists of one or both of 1,3-propene sultone and ethylene sulfate.

In some embodiments, the specific surface area “c” of the negative electrode active material of the battery is 4 m²/g-6 m²/g. The negative electrode active material may be non-metallic materials such as hard carbon, soft carbon, carbon nanotubes, expanded graphite, graphene, and phosphorus, or metallic foils or alloy compounds such as aluminum, tin, and antimony.

In some embodiments, the sodium salt includes one or more of sodium perchlorate (NaClO₄), sodium tetrafluoroborate (NaBF₄), sodium hexafluorophosphate (NaPF₆), sodium trifluoroacetate (CF₃COONa), sodium tetraphenylborate (NaB(C₆H₅)₄), sodium trifluoromethanesulfonate (NaSO₃CF₃), sodium bis(fluorosulfonyl)imide (Na[(FSO₂)₂N]), and sodium bis(trifluoromethylsulfonyl)imide (Na[(CF₃SO₂)₂N]), and the mass percentage content of sodium salt in the electrolyte is 8%-15%, based on 100% by mass of the electrolyte. Specifically, the mass percentage content of sodium salt added to the electrolyte can be 8%, 8.5%, 9.0%, 9.5%, 10.0%, 10.5%, 11%, 11.5%, 12.0%, 12.5%, 13.0%, 13.5%, 14%, 14.5% or 15%, as long as the mass percentage content of sodium salt added is between 8% and 15%.

The non-aqueous organic solvent further comprises an auxiliary solvent, and the auxiliary solvent comprises one or more of carbonates, carboxylates, and ethers; and the mass percentage content of the auxiliary solvent is 60%-85%, based on 100% by mass of the electrolyte.

Preferably, the carbonate-based solvents include a cyclic carbonate or linear carbonate with with 3-5 carbon atoms. The cyclic carbonates include, but are not limited to one or more of the following: ethylene carbonate (EC), vinylene carbonate (VC), vinyl ethylene carbonate (VEC), propylene carbonate (PC), γ-butyrolactone (GBL), butylene carbonate (BC) The linear carbonate specifically include, but are not limited to, dimethyl carbonate (DMC), ethyl methyl carbonate (EMC), diethyl carbonate (DEC) and dipropyl carbonate (DPC).

Preferably, the ester-based solvents include a carboxylate with 2-6 carbon atoms. The carboxylic esters include, but are not limited to one or more of the following: methyl acetate (MA), ethyl acetate (EA), propyl acetate (EP), butyl acetate, propyl propionate (PP). As a preferred solution, the non-aqueous electrolyte for the secondary battery also includes vinylene carbonate (VC), vinyl ethylene carbonate (VEC), and fluoroethylene carbonate (FEC).

Preferably, the ether-based solvents include a cyclic ether or linear ether with 4 to 10 carbon atoms. The cyclic ethers include, but are not limited to one or more of the following: 1,3-dioxolane (DOL), 1,4-dioxooxane (DX), tetrahydrofuran (THF), 2-methyltetrahydrofuran (2-CH₃-THF) and 2-trifluoromethyltetrahydrofuran (2-CF₃-THF). The linear ethers include, but are not limited to, dimethoxymethane (DMM), 1,2-dimethoxyethane (DME), tetraethylene glycol dimethyl ether (TEGDME), one or more of these. The auxiliary solvent with a mass content of 65%-80% forms a co-solvent with the fluoroether solvent represented by Structural Formula 1, with a mass percentage content of 8 wt %-25 wt %, participating in the solvation structure of ions, influencing the composition of the SEI and CEI films on the electrode material surface, and forming structurally stable SEI and CEI films on the electrode material surface, enhancing the interfacial stability between the electrode material and the electrolyte, thereby improving the cycle performance of the sodium-ion secondary battery.

In some embodiments, the additive further includes a fluorinated carbonate ester.

Preferably, the fluorinated carbonate ester comprises one or both of fluoroethylene carbonate and difluoroethylene carbonate;

the mass percentage content of the fluorinated carbonate ester is 1%-5%, based on 100% by mass of the electrolyte. Specifically, the mass percentage content of fluoro-carbonate ester added to the electrolyte can be 1%, 1.5%, 1.9%, 2.0%, 2.5%, 3.0%, 3.5%, 4.0%, 4.5% and 5.0%, as long as the mass percentage content of the fluoro-carbonate ester is within the range of 1%-5%.

In some embodiments, the positive electrode comprises a positive electrode active material, the positive electrode active material comprises one or more of sodium-containing layered oxides, sodium-containing polyanion compounds, and sodium-containing Prussian blue compounds;

the sodium-containing layered oxide comprises one or more compounds represented by Formula (1): NaᵢMO₂ (Formula 1), wherein 0<i≤1, and M is selected from one or more of V, Cr, Mn, Fe, Co, Ni and Cu; the sodium-containing polyanion compound comprises Na₃V₂(PO₄)₂F₃.

Preferably, the sodium-containing layered oxide includes Na[Cu₁₉Ni_{2/9}Fe_{1/3}Mn_{1/3}]O₂, Na_{0.44}MnO₂, Na_{2/3}[Fe_{1/2}Mn_{1/2}]O₂, Na[Ni_{1/3}Fe_{1/3}Mn_{1/3}]O₂, Na_{7/9}[Cu_{2/9}Fe_{1/9}Mn_{2/3}]O₂ and NaNi_{0.7}Co_{0.15}Mn_{0.15}O₂; and the sodium-containing polyanion compound includes Na₃V₂(PO₄)₂F₃.

The sodium-containing Prussian blue compound comprises one or more compounds represented by Formula (2): AₓM″[M′(CN)₆]_{1-y}·□_{y}·zH₂O (Formula 2), wherein 0≤x≤2, 0≤y<1, 0<z≤20; A is an alkali metal ion, M″ is a transition metal coordinated with N, M′ is a transition metal coordinated with C, and represents □ vacancy in [M′(CN)₆].

Preferably, A is selected from one or more of K⁺ and Na⁺; M″ is selected from one or more of Ti, V, Cr, Mn, Fe, Co, Ni, Cu and Zn; M′ is selected from one or more of Ti, V, Cr, Mn, Fe, Co, Ni, Cu and Zn.

Preferably, the sodium-containing Prussian blue compound includes Na₂Fe[Fe(CN)₆], Na_{1.85}Mn[Fe(CN)₆]_{0.96}·□_{0.04}·□_{1.61}H₂O, etc.

In another aspect, the present application provides a method for preparing a sodium-ion secondary battery, comprising the following steps:
Preparation of the positive electrode: uniformly mixing a positive electrode active material, a binder, a conductive agent, and a solvent, coating the mixture onto a substrate, and removing the solvent to obtain a positive electrode;
Preparation of the negative electrode: uniformly mixing a negative electrode active material, a binder, a conductive agent, and a solvent, coating the mixture onto a substrate, and removing the solvent to obtain a negative electrode;
Preparation of the electrolyte: uniformly mixing a sodium salt, an additive, and a non-aqueous organic solvent to obtain an electrolyte, wherein the additive comprises a cyclic sulfate ester, and the non-aqueous organic solvent comprises a fluoroether solvent represented by Structural Formula 1; and
Assembly of the sodium-ion secondary battery: assembling the positive electrode, the negative electrode, and the electrolyte to obtain a sodium-ion secondary battery.

In some embodiments, the positive electrode further includes a positive electrode current collector, and a positive electrode material layer is arranged on the surface of the positive electrode current collector. The positive electrode current collector is selected from metal materials that conduct electrons. Preferably, the positive electrode current collector includes one or more of Al, Ni, Sn, Cu, and stainless steel. In more preferred embodiments, the positive electrode current collector is selected from aluminum foil.

In some embodiments, the positive electrode includes a positive electrode active material layer, and the positive electrode material layer further includes a positive electrode binder and a positive electrode conductive agent. The positive electrode active material, the positive electrode binder, and the positive electrode conductive agent are mixed to form the positive electrode material layer.

The positive electrode binder includes one or more of polyvinylidene fluoride, vinylidene fluoride copolymer, polytetrafluoroethylene, vinylidene fluoride-hexafluoropropylene copolymer, tetrafluoroethylene-hexafluoropropylene copolymer, tetrafluoroethylene-perfluoroalkyl vinyl ether copolymer, ethylene-tetrafluoroethylene copolymer, vinylidene fluoride-tetrafluoroethylene copolymer, vinylidene fluoride-trifluoroethylene copolymer, vinylidene fluoride-trichloroethylene copolymer, vinylidene fluoride-fluoroethylene copolymer, vinylidene fluoride-hexafluoropropylene-tetrafluoroethylene copolymer, and thermoplastic resins such as thermoplastic polyimide, polyethylene and polypropylene; acrylic resin; carboxyl methylcellulose sodium; and styrene butadiene rubber. The positive electrode conductive agent includes one or more of conductive carbon black, conductive carbon spheres, conductive graphite, conductive carbon fibers, carbon nanotubes, graphene, or reduced graphene oxide.

In some embodiments, the negative electrode also includes a negative electrode current collector, with the negative electrode material layer arranged on the surface of the negative electrode current collector. The material of the negative electrode current collector may be the same as that of the positive electrode current collector, which will not be repeated here.

In some embodiments, the negative electrode material layer also includes a negative electrode binder and a negative electrode conductive agent. The negative electrode active material, the negative electrode binder, and the negative electrode conductive agent are mixed to form the negative electrode material layer. The negative electrode binder and conductive agent may be the same as the positive electrode binder and conductive agent, which will not be repeated here. In some embodiments, the secondary battery further includes a separator, with the separator located between the positive electrode and the negative electrode.

The separator can be a conventional separator, such as a ceramic separator, polymer separator, nonwoven fabric, or inorganic-organic composite separator, including but not limited to single-layer PP (polypropylene), single-layer PE (polyethylene), double-layer PP/PE, double-layer PP/PP, and three-layer PP/PE/PP separators.

The following embodiments further illustrate the present application.

### Embodiment 1

This embodiment is used to illustrate the sodium-ion secondary battery disclosed in the present application.

(1) Preparation of Fluoroether: The synthesis method of the fluoroether of the present application can be achieved by reacting the corresponding alcohol with alcohol reagents or other alkylating agents, in an NMP solvent, under NaOH catalysis to produce the corresponding ether.

For example, in Embodiment 1, 2,2,3,3,4,4,5,5-octafluoro-1-pentanol was used, and under NaOH catalysis in an NMP solvent, it reacted with ethanol to yield 2,2,3,3,4,4,5,5-octafluoropentyl ethyl ether.

The electrolyte composition is as follows (based on 100% by mass of the electrolyte): the auxiliary solvents selected include 20% by mass of ethylene carbonate (EC), 9% by mass of propylene carbonate (PC), and 40% by mass of ethyl methyl carbonate (EMC); 2,2,3,3,4,4,5,5-octafluoropentyl ethyl ether is added at 8% by mass; the sodium salt is sodium hexafluorophosphate, added at 13 wt %; and the additives selected include 2% by mass of fluoroethylene carbonate (FEC), with the cyclic sulfate ester compounds comprising 1% by mass of 1,3-propene sultone (RPS) and 2% by mass of ethylene sulfate (DTD).

(1) Preparation of the electrolyte: In a glove box filled with argon (moisture <0.1 ppm, oxygen <0.1 ppm), the aforementioned auxiliary solvents, fluoroether solvent represented by Structural Formula 1, and additives were added to a stirring container and mixed uniformly to prepare the electrolyte.

The viscosity of the electrolyte at 25° C. is tested, and the data is shown in Table 1.

(2) Preparation of the sodium-ion secondary battery includes the following steps:

Preparation of the positive electrode: The positive electrode active material NaNi_{0.7}Co_{0.15}Mn_{0.15}O₂, conductive carbon black Super-P, and binder polyvinylidene fluoride (PVDF) were mixed at a mass ratio of 93:4:3. The mixture was then dispersed in an appropriate amount of N-methyl-2-pyrrolidone (NMP) to form a positive electrode slurry. The slurry was evenly coated on both sides of aluminum foil, then dried, rolled, and vacuum dried. After ultrasonic welding with aluminum lead tabs, the positive electrode plate was obtained, with a thickness of 120-150 μm.

Preparation of the negative electrode: The negative electrode active material, hard carbon, with a specific surface area of 5 m²/g, conductive carbon black Super-P, binder styrene-butadiene rubber (SBR), and carboxymethyl cellulose (CMC) were mixed at a mass ratio of 94:1:2.5:2.5. The mixture was dispersed in an appropriate amount of deionized water to form a negative electrode slurry. The slurry was coated on both sides of copper foil, then dried, rolled, and vacuum dried. After ultrasonic welding with nickel lead tabs, the negative electrode plate was obtained, with a thickness of 120-150 μm.

(3) Preparation of the sodium-ion secondary battery: A three-layer separator with a thickness of 20 μm was placed between the prepared positive electrode and negative electrode plates. The sandwich structure of the positive electrode, negative electrode, and separator was then wound, flattened, and placed into an aluminum foil pouch. It was vacuum-dried at 75° C. for 48 hours to obtain a battery cell ready for electrolyte injection. In a glove box with a dew point controlled to below −40° C., the prepared electrolyte was injected into the cell, followed by vacuum sealing and resting for 24 hours.

### Embodiments 2-14

The difference between Embodiments 2-14, Comparative Examples 1-11, and Embodiment 1 lies in the mass percentage content of the fluoroether solvent represented by Structural Formula 1, the cyclic sulfate ester compound, and the specific surface area of the negative electrode active material. All other aspects are the same as Embodiment 1, as shown in the following Table 1.

### Comparative Examples 12-13

The difference between Embodiment 1 and Comparative Example 12-13 lies in the use of existing fluoroether solvents, the different mass percentages of the cyclic sulfate ester compound, and the different specific surface areas of the negative electrode active material. All other aspects are the same as Embodiment 1, as shown in the following Table 1.

The viscosity of the electrolytes of Embodiments 1-14 and Comparative Examples 1-13 at 25° C., and the value of the relation (a·d)/(b·c), were tested, with the results shown in Table 1. The fluoroether solvent represented by Structural Formula 1 added in Embodiments 1-14 is 2,2,3,3,4,4,5,5-octafluoropentyl ethyl ether.

TABLE 1
Parameter Table of Electrolyte and Battery for Embodiments 1-14 and Comparative Examples 1-13

| | | | | Specific | | |
|---|---|---|---|---|---|---|
| | Mass content of | | | surface area | | |
| | the fluoroether | Existing | | “c” of the | Viscosity | |
| | solvent | fluoroether | Cyclic | negative | of the | |
| | represented by | solvent | sulfate ester | electrode | electrolyte | |
| | Structural | and mass | and mass | active | at 25° C. | |
| Group | Formula 1 a/% | content/% | content b/% | material/m²/g | d/mPa · s | (a · d)/(b · c) |
| Embodiment 1 | 8 | / | 1% RPS | 5 | 3.2 | 2.6 |
| | | | 1% DTD | | | |
| Embodiment 2 | 8 | / | 3% RPS | 4 | 3.1 | 2.1 |
| Embodiment 3 | 8 | / | 1% RPS | 7 | 2.4 | 0.9 |
| | | | 2% DTD | | | |
| Embodiment 4 | 25 | / | 1% DTD | 7 | 3.1 | 3.7 |
| Embodiment 5 | 14 | / | 1% RPS | 5 | 4.7 | 4.4 |
| | | | 2% DTD | | | |
| Embodiment 6 | 14 | / | 1% RPS | 7 | 4.5 | 4.5 |
| | | | 1% DTD | | | |
| Embodiment 7 | 10 | / | 1% DTD | 6 | 3.8 | 6.3 |
| Embodiment 8 | 14 | / | 1% RPS | 5 | 4.5 | 6.3 |
| | | | 1% DTD | | | |
| Embodiment 9 | 18 | / | 1% RPS | 4 | 4.8 | 7.2 |
| | | | 2% DTD | | | |
| Embodiment 10 | 14 | / | 1% RPS | 4 | 5 | 8.8 |
| | | | 1% DTD | | | |
| Embodiment 11 | 15 | / | 1% RPS | 6 | 4.2 | 10.5 |
| Embodiment 12 | 20 | / | 1% RPS | 5 | 6.9 | 13.8 |
| | | | 1% DTD | | | |
| Embodiment 13 | 22 | / | 1% RPS | 6 | 4.6 | 16.9 |
| Embodiment 14 | 12 | / | 0.5% DTD | 5 | 4.1 | 19.7 |
| Comparative | 0 | / | 1% RPS | 5 | 2.5 | 0 |
| example 1 | | | 1% DTD | | | |
| Comparative | 0 | / | 0 | 5 | 2.78 | 0 |
| example 2 | | | | | | |
| Comparative | 20 | / | 0 | 5 | 6.7 | 0 |
| example 3 | | | | | | |
| Comparative | 30 | / | 1% RPS | 5 | 8.1 | 24.3 |
| example 4 | | | 1% DTD | | | |
| Comparative | 6 | / | 1% RPS | 5 | 2.1 | 0.8 |
| example 5 | | | 2% DTD | | | |
| Comparative | 14 | / | 1% RPS | 7 | 4.5 | 2.6 |
| example 6 | | | 2.5% DTD | | | |
| Comparative | 12 | / | 0.2% DTD | 5 | 4.2 | 50.4 |
| example 7 | | | | | | |
| Comparative | 6 | / | 1% RPS | 5 | 2.1 | 0.7 |
| example 8 | | | 2.5% DTD | | | |
| Comparative | 14 | / | 1% RPS | 8 | 4.5 | 3.9 |
| example 9 | | | 1% DTD | | | |
| Comparative | 14 | / | 1% RPS | 2 | 4.4 | 10.3 |
| example 10 | | | 2% DTD | | | |
| Comparative | 14 | / | 0.5DTD | 5 | 4.3 | 24.1 |
| example 11 | | | | | | |
| Comparative | / | Heptafluoropropyl | 1% RPS | 5 | 5.6 | 7.8 |
| example 12 | | methyl ether/14% | 1% DTD | | | |
| Comparative | / | 2,2,3,3,4,4,5- | 1% RPS | 5 | 5.9 | 8.3 |
| example 13 | | heptafluoropentyl | 1% DTD | | | |
| | | butyl ether/14% | | | | |

The sodium-ion secondary batteries were prepared using the electrolytes formulated according to Embodiments 1-14 and Comparative Examples 1-13, with a voltage range of 1.5-3.9V. The electrochemical performance of the sodium-ion secondary batteries were tested, and the test results are shown in Table 2.

### Electrochemical Performance Test of Sodium-Ion Secondary Batteries:

### 1) First-Cycle Test:

At room temperature, the batteries were charged at a constant current of 0.2C to 3.9V. Then, constant voltage charging was applied until the charging current dropped to 0.02C. The initial capacity C0 was measured, followed by a constant current discharge at 0.2C to 1.5V to obtain the discharge capacity C1.

$$First - cycle efficiency = ( C 1 / C 0 ) \times 100 \%$$

### 2) Cycle Performance Test:

### 45° C. High-Temperature Cycle Test:

The batteries were placed in a 45° C. high-temperature environment, charged at a constant current of 0.7C to 3.9V. Then, constant voltage charging was applied until the charging current dropped to 0.02C. Afterward, the batteries were discharged at a constant current of 1C to 1.5V, and this process was repeated for 200 cycles.

The capacity retention after 200 cycles is calculated as:

(Discharge capacity in the 200th cycle/Discharge capacity in the 1st cycle)×100%,

### 25° C. Room-Temperature Cycle Test:

The batteries were placed in a 25° C. room-temperature environment, charged at a constant current of 0.7C to 3.9V, followed by constant voltage charging to 3.9V until the charging current dropped to 0.05C. The batteries were then discharged at a constant current of 1C to 1.5V, and this process was repeated for 200 cycles.

The capacity retention after 200 cycles is calculated as:

$$( Discharge capacity in the 200 th cycle / Average discharge capacity in the 1 st to 3 rd cycles ) \times 100 \% .$$

TABLE 2
Table of Electrochemical Performance Test Data for
Embodiments 1-14 and Comparative Examples 1-13

| | | Capacity | Capacity |
|---|---|---|---|
| | | retention after | retention after |
| | First cycle | 200 cycles | 200 cycles |
| Group | efficiency/% | at 25° C./% | at 45° C./% |
| Embodiment 1 | 80.1 | 94.0 | 92.5 |
| Embodiment 2 | 80.0 | 92.1 | 92.9 |
| Embodiment 3 | 80.2 | 93.6 | 92.3 |
| Embodiment 4 | 79.9 | 92.8 | 91.9 |
| Embodiment 5 | 80.9 | 94.2 | 93.8 |
| Embodiment 6 | 78.9 | 90.3 | 89.4 |
| Embodiment 7 | 79.6 | 91.6 | 93.4 |
| Embodiment 8 | 80.9 | 94.5 | 93.8 |
| Embodiment 9 | 80.4 | 93.9 | 93.2 |
| Embodiment 10 | 80.6 | 94.1 | 93.0 |
| Embodiment 11 | 79.8 | 92.9 | 93.1 |
| Embodiment 12 | 80.1 | 92.7 | 93.8 |
| Embodiment 13 | 79.4 | 92.1 | 90.9 |
| Embodiment 14 | 78.4 | 90.6 | 89.5 |
| Comparative | 72.8 | 79.9 | 77.8 |
| example 1 | | | |
| Comparative | 71.4 | 74.3 | 71.2 |
| example 2 | | | |
| Comparative | 76.6 | 88.1 | 87.2 |
| example 3 | | | |
| Comparative | 79.1 | 78.3 | 79.2 |
| example 4 | | | |
| Comparative | 79.2 | 76.4 | 74.2 |
| example 5 | | | |
| Comparative | 76.8 | 87.0 | 86.3 |
| example 6 | | | |
| Comparative | 76.1 | 84.3 | 83.6 |
| example 7 | | | |
| Comparative | 77.2 | 78.3 | 76.4 |
| example 8 | | | |
| Comparative | 77.6 | 89.5 | 88.4 |
| example 9 | | | |
| Comparative | 76.1 | 90.6 | 89.5 |
| example 10 | | | |
| Comparative | 76.8 | 86.5 | 83.8 |
| example 11 | | | |
| Comparative | 77.5 | 76.2 | 75.1 |
| example 12 | | | |
| Comparative | 76.2 | 73.6 | 71.9 |
| example 13 | | | |

As shown in Tables 1 and 2, it can be observed that, compared with Embodiments 1-14 and Comparative Examples 1-13, in Comparative Example 2, the absence of the fluoroether solvent represented by Structural Formula 1 and the cyclic sulfate ester compound additive resulted in a lower first-cycle efficiency and capacity retention. In Comparative Example 1, the inclusion of the cyclic sulfate ester compound additive led to a slight improvement in the first-cycle efficiency and cycle performance. In Comparative Example 3, the addition of the fluoroether solvent represented by Structural Formula 1 resulted in a greater improvement in the first-cycle efficiency and cycle performance compared to Comparative Example 1. This suggests that the addition of the fluoroether solvent represented by Structural Formula 1 in the electrolyte helps form stable CEI and SEI films on the positive and negative electrode surfaces, contributing to enhanced cycle performance and first-cycle efficiency. In Comparative Example 4, an excessive amount of fluoroether solvent represented by Structural Formula 1 led to reduced cycle performance, indicating that adding too much fluoroether solvent (with an (a·d)/(b·c) value greater than 20) increased the viscosity of the electrolyte, decreased the solubility of sodium salts, and impaired the battery's cycle performance. In Comparative Example 5, a lower amount of fluoroether solvent represented by Structural Formula 1 (with an (a·d)/(b·c) value less than 0.9) significantly reduced the cycle performance, indicating that when the fluoroether solvent represented by Structural Formula 1 is less than 8%, the conductivity of the electrolyte decreases, thereby lowering the cycle performance of the battery.

Compared to Embodiment 6, in Comparative Example 6, an excessive amount of cyclic sulfate ester compound is added to the electrolyte. Although the relationship (a·d)/(b·c) satisfies the condition 0.9<(a·d)/(b·c)<20, the battery's initial efficiency and cycle performance are reduced. This indicates that when the cyclic sulfate ester compound content exceeds 3%, the cyclic carbonate additive overly participates in the formation of the CEI and SEI films at the electrode material interface. The increased film thickness leads to higher battery impedance, more side reactions, and increased irreversible capacity loss, resulting in decreased initial efficiency and cycle performance. In Comparative Example 8, further reduction of the fluoroether solvent represented by Structural Formula 1 results in a further decrease in both initial efficiency and cycle performance. This suggests that when the cyclic sulfate ester compound content exceeds 3%, and the fluoroether solvent represented by Structural Formula 1 is reduced, there is no improvement in the battery's cycle performance or initial efficiency. In Comparative Example 7, compared to Embodiment 14, the cyclic sulfate ester content is below 0.5%, failing to meet the condition 0.9<(a·d)/(b·c)<20. This results in a significant decline in both initial efficiency and cycle performance, indicating poor film formation on the electrode material surface, which deteriorates the initial efficiency and reduces the cycle performance of the sodium-ion secondary battery. Compared to Embodiments 6, 8, and 10, and Comparative Examples 9-10, in Comparative Example 9, the negative electrode active material has a specific surface area greater than 7 m²/g, while in Comparative Example 10, the specific surface area of the negative electrode active material is less than 4 m²/g. Although it satisfies the condition 0.9<(a·d)/(b·c)<20, the battery still exhibits lower initial efficiency and cycle performance. It is speculated that the specific surface area of the negative electrode active material affects the electrolyte's wetting and the formation of the SEI film on the negative electrode material surface, thereby impacting the cycle performance and initial efficiency of the battery. When comparing Embodiments 1-14 with Comparative Example 11, the fluoroether compound content represented by Structural Formula 1 in Comparative Example 11 is within the range of 8%-25%, the cyclic sulfate ester compound content is in the range of 0.5%-3%, and the specific surface area of the negative electrode active material is between 4 and 7 m²/g. The relationship (a·d)/(b·c) is 24.1, which does not satisfy the condition 0.9<(a·d)/(b·c)<20. As a result, the battery exhibits lower initial efficiency and cycle performance. It is speculated that because it does not meet the required range of 0.9<(a·d)/(b·c)<20, a stable SEI and CEI film cannot form on the electrode material surface, which adversely affects the cycle performance and initial efficiency of the battery.

Compared to Embodiments 6, 8, and 10, and Comparative Examples 12-13, when conventional fluoroether solvents are added to the electrolyte, the battery shows lower cycle performance and initial efficiency. This indicates that the fluoroether solvent represented by Structural Formula 1 provided in this application can enhance the solubility of sodium salts in the electrolyte, ensuring that the electrolyte contains a sufficient amount of sodium salts, which guarantees the electrolyte's conductivity and improves the cycle performance and initial efficiency of sodium-ion secondary batteries.

In comparison with Embodiments 1-14, when the content of the fluoroether solvent represented by Structural Formula 1 is in the range of 10%-22%, the cyclic sulfate ester content is within the range of 1%-3%, and the specific surface area of the negative electrode active material is in the range of 4-6 m²/g, the relationship falls within the range of 2<(a·d)/(b·c)<16. The battery demonstrates better cycle performance and higher initial efficiency.

### First-Cycle Efficiency Testing of Sodium-Ion Secondary Batteries at Various Discharge Rates:

1) First-cycle efficiency test: At room temperature, the prepared sodium-ion secondary batteries were charged to 3.9V at a rate of 0.2C, and then charged at constant voltage until the current dropped to 0.02C. The initial capacity C0 of the battery was measured. Then, the batteries were discharged at a constant current of 0.2C to 1.5V to obtain the discharge capacity C1. The first-cycle efficiency is calculated as follows: First-cycle efficiency=C1/C0×100%.

The electrolytes prepared according to Embodiment 12 and Comparative Examples 3 and 9 were used to prepare sodium-ion secondary batteries, which were then discharged at constant currents of 0.5C, 1C, 2C, and 3C. The first-cycle efficiency at different discharge rates was tested, and the results are shown in Table 3.

TABLE 3
First-cycle efficiency of the batteries tested at different discharge rates
for Embodiment 12, Comparative example 1, and Comparative example 3.

| | First-cycle | First-cycle | First-cycle | First-cycle | First-cycle |
|---|---|---|---|---|---|
| | efficiency of | efficiency of | efficiency of | efficiency of | efficiency of |
| | the battery | the battery | the battery | the battery | the battery |
| | at a 0.2 C | at a 0.5 C | at a 1.0 C | at a 2 C | at a 3 C |
| | discharge | discharge | discharge | discharge | discharge |
| Group | current/% | current/% | current/% | current/% | current/% |
| Embodiment 12 | 80.1 | 77.5 | 75.6 | 73.5 | 71.8 |
| Comparative | 77.6 | 74.9 | 73.0 | 70.8 | 69.2 |
| example 13 | | | | | |
| Comparative | 76.6 | 74.1 | 71.4 | 68.2 | 66.5 |
| example 1 | | | | | |

Through Table 3, it can be seen that in Comparative example 1, where no fluoroether solvent represented by Structural Formula 1 was added, the battery's first-cycle efficiency (FCE) at different discharge rates was lower than that of Embodiment 12. In Comparative example 13, where an existing fluoroether solvent was used, the improvement in first-cycle efficiency was relatively modest. The battery in Embodiment 12 exhibited significantly higher first-cycle efficiency at 0.2C, 0.5C, 1C, 2C, and 3C discharge rates compared to Comparative examples 1 and 13. This indicates that when the electrolyte contains the fluoroether solvent represented by Structural Formula 1 in the range of 8-25%, cyclic sulfate ester compound content (b) between 0.5-3%, and the specific surface area (c) of the negative electrode active material controlled within 4-7 m²/g, while satisfying the relationship of 0.9≤(a·d)/(b·c)≤20, it facilitates the formation of stable CEI and SEI films on the electrode material's surface, thereby enhancing the battery's first-cycle efficiency.

Testing of the Electrochemical Performance of Sodium-Ion Secondary Batteries with Different Fluoroethers:

Table 4 shows the electrolyte and battery parameter data for Embodiments 7, 15-17. The difference between Embodiments 15-17 and Embodiment 7 lies in the different types of fluoroether solvents represented by Structural Formula 1 added to the electrolyte, while the rest is the same as Embodiment 1. The viscosity of the electrolytes of Embodiments 15-17 at 25° C. and the values of the relationship (a·d)/(b·c) were tested, and the results are shown in Table 4.

TABLE 4
Table of Electrolyte and Battery Parameter Data for Embodiment 7, 15-17

| | | | Specific | | |
|---|---|---|---|---|---|
| | | | surface area | | |
| | | Cyclic | “c” of the | | |
| | | sulfate | negative | Viscosity | |
| | Type and mass content of | ester and | electrode | of the | |
| | the fluoroether solvent | mass | active | electrolyte | |
| | represented by Structural | content | material/ | at 25° C. | (a · d)/ |
| Group | Formula 1 a/% | b/% | m²/g | d/mPa · s | (b · c) |
| Embodiment 7 | 2,2,3,3,4,4,5,5- | 1% RPS | 5 | 4.7 | 4.4 |
| | octafluoropentyl ethyl | 2% DTD | | | |
| | ether/14% | | | | |
| Embodiment 15 | 2,2,3,3,4,4,5,5- | 1% RPS | 5 | 5.3 | 4.9 |
| | octafluoropentyl methyl | 2% DTD | | | |
| | ether/14% | | | | |
| Embodiment 16 | 2,2,3,3,4,4-hexafluorobutyl | 1% RPS | 5 | 4.1 | 3.8 |
| | methyl ether/14% | 2% DTD | | | |
| Embodiment 17 | 2,3,3,4,4,5,5- | 1% RPS | 5 | 4.6 | 4.3 |
| | heptafluoropentyl ethyl | 2% DTD | | | |
| | ether/14% | | | | |

Table 5 shows the battery performance test data for Embodiments 7, 15-17. The battery performance was tested using the same method as Embodiment 7, and the test results are shown in the table below.

TABLE 5
Table of battery performance test data for Embodiments 7, 15-17

| | | Capacity | Capacity |
|---|---|---|---|
| | | retention | retention |
| | | after 200 | after 200 |
| | First cycle | cycles at | cycles |
| Group | efficiency/% | 25° C./% | at 45° C./% |
| Embodiment 7 | 80.9 | 94.2 | 93.8 |
| Embodiment 15 | 80.6 | 939 | 93.4 |
| Embodiment 16 | 80.8 | 94.1 | 93.6 |
| Embodiment 17 | 80.7 | 93.8 | 93.3 |

Based on Tables 4-5, it can be seen that when the fluoroether compound is added to the electrolyte, as long as it meets the fluoroether represented by Structural Formula 1, the first-cycle efficiency, room temperature cycle capacity retention, and high-temperature cycle capacity retention data of the resulting battery are relatively close, all of which can improve the battery's first-cycle efficiency and cycle performance. This demonstrates that the addition of the fluoroether solvent represented by Structural Formula 1 can work together with the cyclic sulfate ester compound in the electrolyte to form stable SEI and CEI films on the surface of the electrode materials, thereby improving the battery's first-cycle efficiency and cycle performance.

The above are only preferred embodiments of the present application and are not intended to limit the scope of the application. Any modifications, equivalent substitutions, or improvements made within the spirit and principle of the present application should be included within the scope of protection of the application.

1. A sodium-ion secondary battery, comprising a positive electrode, a negative electrode, and an electrolyte, wherein the negative electrode comprises a negative electrode active material, the electrolyte comprises a sodium salt, an additive, and a non-aqueous organic solvent, the additive comprises a cyclic sulfate ester, and the non-aqueous organic solvent comprises a fluoroether solvent represented by Structural Formula 1:
FₓCₙH₂ₙ₊₁₋ₓOCₘH₂ₘ₊₁ Structural Formula 1
wherein x/(2n+1)<0.8, n/m>1.5; 4≤n≤10, 1≤m≤5;
the sodium-ion secondary battery satisfies the following relational expression:
$$0.9 \leq ( a \cdot d ) / ( b \cdot c ) \leq 20 ;$$
wherein, 8%≤a≤25%, 0.5%≤b≤3%, 4 m²/g≤c≤7 m²/g;
a represents a mass percentage content of the fluoroether solvent represented by Structural Formula 1 in the electrolyte, in %;
b represents a mass percentage content of the cyclic sulfate ester in the electrolyte, in %;
c represents a specific surface area of the negative electrode active material, in m²/g; and
d represents a viscosity of the electrolyte at 25° C., in mPa·s.

2. The sodium-ion secondary battery of claim 1, wherein the sodium-ion secondary battery satisfies the following relational expression:
2≤(a·d)/(b·c)≤16.

3. The sodium-ion secondary battery of claim 1, wherein the fluoroether solvent represented by Structural Formula 1 comprises one or more of the following:
2,2,3,3,4,4,5,5-octafluoropentyl methyl ether, 2,2,3,3,4,4,5,5-octafluoropentyl ethyl ether, 2,3,3,4,4,5,5-heptafluoropentyl methyl ether, 2,3,3,4,4,5,5-heptafluoropentyl ethyl ether, 2,2,3,3,4,4,5-heptafluoropentyl methyl ether, 2,2,3,3,4,4,5-heptafluoropentyl ethyl ether, 3,3,4,4,5,5-hexafluoropentyl methyl ether, 3,3,4,4,5,5-hexafluoropentyl ethyl ether, 2,2,3,3,4,4-hexafluorobutyl methyl ether, 2,2,3,3,4,4-hexafluoropentyl methyl ether and 2,2,3,3,4,4-hexafluorobutyl ethyl ether.

4. The sodium-ion secondary battery of claim 3, wherein the fluoroether solvent represented by Structural Formula 1 comprises one or more of the following:
2,2,3,3,4,4,5,5-octafluoropentyl ethyl ether, 2,2,3,3,4,4,5,5-octafluoropentyl methyl ether and 2,3,3,4,4,5,5-heptafluoropentyl methyl ether.

5. The sodium-ion secondary battery of claim 3, wherein the mass percentage content (a) of the fluoroether solvent represented by Structural Formula 1 is 10%-22%, based on 100% by mass of the electrolyte.

6. The sodium-ion secondary battery of claim 1, wherein the cyclic sulfate ester comprises one or more of the following:
1,3-propane sultone, 1,3-propene sultone, ethylene sulfate, 4-methyl ethyl sulfate, 4-propyl ethyl sulfate, propylene sulfate, 4-methyl propyl sulfate and 4-propyl propylene sulfate; and the mass percentage content (b) of the cyclic sulfate ester is 1%-3%, based on 100% by mass of the electrolyte.

7. The sodium-ion secondary battery of claim 4, wherein the cyclic sulfate ester consists of one or both of 1,3-propene sultone and ethylene sulfate.

8. The sodium-ion secondary battery of claim 1, wherein the negative electrode active material comprises one or more of soft carbon, hard carbon, carbon nanotubes, expanded graphite, and graphene, and the specific surface area (c) of the negative electrode active material is 4 m²/g to 6 m²/g.

9. The sodium-ion secondary battery of claim 1, wherein the sodium salt includes one or more of sodium perchlorate (NaClO₄), sodium tetrafluoroborate (NaBF₄), sodium hexafluorophosphate (NaPF₆), sodium trifluoroacetate (CF₃COONa), sodium tetraphenylborate (NaB(C₆H₅)₄), sodium trifluoromethanesulfonate (NaSO₃CF₃), sodium bis(fluorosulfonyl)imide (Na[(FSO₂)₂N]), and sodium bis(trifluoromethylsulfonyl)imide (Na[(CF₃SO₂)₂N]), and the mass percentage content of sodium salt in the electrolyte is 8%-15%, based on 100% by mass of the electrolyte.

10. The sodium-ion secondary battery of claim 1, wherein the non-aqueous organic solvent further comprises an auxiliary solvent, and the auxiliary solvent comprises one or more of carbonates, carboxylates, and ethers.

11. The sodium-ion secondary battery of claim 10, wherein the carbonate comprises a cyclic carbonate or linear carbonate with 3 to 5 carbon atoms, the cyclic carbonate comprises one or more of ethylene carbonate, vinylene carbonate, vinyl ethylene carbonate, propylene carbonate, γ-butyrolactone, and butylene carbonate;
the linear carbonate comprises one or more of dimethyl carbonate, ethyl methyl carbonate, diethyl carbonate and dipropyl carbonate;
the carboxylate comprises a carboxylate with 2 to 6 carbon atoms, the carboxylate comprises one or more of methyl acetate, ethyl acetate, propyl acetate, butyl acetate, and propyl propionate with 2 to 6 carbon atoms;
the ether comprises a cyclic ether or linear ether with 4 to 10 carbon atoms, the cyclic ether comprises one or more of 1,3-dioxolane, 1,4-dioxooxane, tetrahydrofuran, 2-methyltetrahydrofuran and 2-trifluoromethyltetrahydrofuran; the linear ether comprises one or more of dimethoxymethane, 1,2-dimethoxyethane (DME), and diglyme; and
the mass percentage content of the auxiliary solvent is 60%-85%, based on 100% by mass of the electrolyte.

12. The sodium-ion secondary battery of claim 10, wherein the mass percentage content of the auxiliary solvent is 65%-80%, based on 100% by mass of the electrolyte.

13. The sodium-ion secondary battery of claim 1, wherein the additive further includes a fluorinated carbonate ester.

14. The sodium-ion secondary battery of claim 13, wherein the fluorinated carbonate ester comprises one or both of fluoroethylene carbonate and difluoroethylene carbonate; the mass percentage content of the fluorinated carbonate ester is 1%-5%, based on 100% by mass of the electrolyte.

15. The sodium-ion secondary battery of claim 1, wherein the positive electrode comprises a positive electrode active material, the positive electrode active material comprises one or more of sodium-containing layered oxides, sodium-containing polyanion compounds, and sodium-containing Prussian blue compounds;
the sodium-containing layered oxide comprises one or more compounds represented by Formula (1): NaᵢMO₂ (Formula 1), wherein 0<i≤1, and M is selected from one or more of V, Cr, Mn, Fe, Co, Ni and Cu; the sodium-containing polyanion compound comprises Na₃V₂(PO₄)₂F₃; and
the sodium-containing Prussian blue compound comprises one or more compounds represented by Formula (2): AₓM″[M′(CN)₆]_{1-y}·□_{y}·zH₂O (Formula 2), wherein 0≤x≤2, 0≤y<1, 0<z≤20; A is an alkali metal ion, M″ is a transition metal coordinated with N, M′ is a transition metal coordinated with C, and represents a vacancy in [M′(CN)₆].

16. The sodium-ion secondary battery of claim 15, wherein A is selected from one or more of K⁺ and Na⁺; M″ is selected from one or more of Ti, V, Cr, Mn, Fe, Co, Ni, Cu and Zn; M′ is selected from one or more of Ti, V, Cr, Mn, Fe, Co, Ni, Cu and Zn.

17. The sodium-ion secondary battery of claim 11, wherein the mass percentage content of the auxiliary solvent is 65%-80%, based on 100% by mass of the electrolyte.
